(19) United States
(12) Patent Application Publication
(10) Pub. No.: US 2020/0203883 A1
(43) Pub. Date: Jun. 25, 2020

(54) CONNECTOR

(71) Applicant: Yazaki Corporation, Tokyo (JP)

(72) Inventors: Takakazu TAKAHASHI, Shizuoka (JP); Rikuto ISHIHARA, Shizuoka (JP)

(73) Assignee: Yazaki Corporation, Tokyo (JP)

(21) Appl. No.: 16/720,572

(22) Filed: Dec. 19, 2019

(30) Foreign Application Priority Data
Dec. 20, 2018 (JP) 2018-237973

(51) Int. Cl. H01R 13/58; H01R 13/502

(52) U.S. Cl. CPC H01R 13/5808; H01R 13/502

(57) ABSTRACT

A connector includes an outer housing, an inner housing housed and held in the outer housing, a jacket fixing member attached to an outer periphery of the inner housing, a plurality of terminals housed in the inner housing, a plurality of cables with each end connected to each of the plurality of terminals and drawn from the inner housing, a jacket collectively covering an outer periphery of the plurality of cables drawn from the inner housing, a crimping section formed on the jacket fixing member and crimped to an outer periphery of the jacket, and at least one serration formed on the crimping section, protruding toward the jacket, and arranged inclined with respect to a longitudinal direction of the jacket.

### CROSS REFERENCE TO RELATED APPLICATION

The present application is based on, and claims priority from the prior Japanese Patent Application No. 2018-237973, filed on Dec. 20, 2018, the entire contents of which are incorporated herein by reference.

### TECHNICAL FIELD

The disclosure relates to a connector. Particularly, the present invention relates to a connector with a crimping section that crimps a jacket covering an outer periphery of a plurality of cables to a jacket fixing member attached to an inner housing.

### BACKGROUND

Known in the related art is a connector that includes an external housing, a holding member housed and held in the external housing, an upper shell attached to an outer periphery of the holding member, a plurality of terminals housed in the holding member, a plurality of cables with ends each connected with the plurality of terminals and drawn from the holding member, an outer member collectively covering an outer periphery of the plurality of cables drawn from the holding member, and a crimping section provided on the upper shell and crimped to an outer periphery of the outer member (see JP 2017-204335 A).

This connector can keep each member attached by attaching the upper shell to the outer periphery of the holding member while the plurality of terminals is housed in the holding member and crimping the outer periphery of the outer member collectively covering the outer periphery of the plurality of cables drawn from the holding member by the crimping section.

### SUMMARY

Meanwhile, in the foregoing connector, a plurality of cables may not completely adhere to a jacket, and a space (gap) may exist between the plurality of cables and the jacket.

In such a case, even if a crimping section is crimped to an outer periphery of the jacket, a space may remain between the plurality of cables and the jacket.

When a space remains between the plurality of cables and the jacket, the jacket escapes toward the plurality of cables at the crimping section, and a holding force of the crimping section with respect to the jacket is reduced.

Accordingly, when a tensile force is applied to the plurality of cables and the jacket in a direction away from an inner housing, a crimping position, in the crimping section, with respect to the jacket may be shifted, or the jacket may be detached from the crimping section.

An object of the present embodiment is to provide a connector that can improve a holding force of a crimping section with respect to a jacket.

A connector according to the embodiment includes an outer housing, an inner housing housed and held in the outer housing, a jacket fixing member attached to an outer periphery of the inner housing, a plurality of terminals housed in the inner housing, a plurality of cables with each end connected to each of the plurality of terminals and drawn from the inner housing, a jacket collectively covering an outer periphery of the plurality of cables drawn from the inner housing, a crimping section formed on the jacket fixing member and crimped to an outer periphery of the jacket, and at least one serration formed on the crimping section, protruding toward the jacket, and arranged inclined with respect to a longitudinal direction of the jacket.

In this connector, the serration protruding toward the jacket and arranged inclined with respect to the longitudinal direction of the jacket are formed in the crimping section. Thus, when the crimping section is crimped to the outer periphery of the jacket, the serration can be arranged to bite into the outer periphery of the jacket.

In addition, since the serration is arranged inclined with respect to the longitudinal direction of the jacket, compared with a case where the serration is arranged orthogonal to the longitudinal direction of the jacket, a length of the serration at the crimping section can be increased. Thus, a biting amount of the serration with respect to the jacket can be increased.

Therefore, in the foregoing connector, even if a space remains between the plurality of cables and the jacket, the serration can be made stably bite into the outer periphery of the jacket, and the holding force of the crimping section with respect to the jacket can be improved.

A corner portion of the at least one serration protruded toward the jacket may be rounded.

When the corner portion of the serration protruded toward the jacket is rounded, the corner portion of the serration can prevent damages to the jacket when a tensile force is applied to the plurality of cables of the jacket.

The at least one serration may include a plurality of serrations.

When the at least one serration includes a plurality of serrations, the holding force of the crimping section with respect to the jacket can be further improved.

With a configuration described above, a connector that can improve the holding force of the crimping section with respect to the jacket can be provided.

### BRIEF DESCRIPTION OF THE DRAWINGS

FIG. 1 is a perspective view of a connector according to an embodiment;

FIG. 2 is a cross-sectional view of the connector according to the embodiment;

FIG. 3 is an enlarged cross-sectional view of a main part of the connector according to the embodiment;

FIG. 4 is an enlarged cross-sectional view for illustrating the main part of the connector according to the embodiment;

FIG. 5 is a perspective view illustrating the connector according to the embodiment before a jacket fixing member is attached to an inner housing;

FIG. 6 is a perspective view illustrating the connector according to the embodiment with the jacket fixing member attached to the inner housing; and

FIG. 7 is a top view of the jacket fixing member of the connector according to the embodiment.

### DETAILED DESCRIPTION

Various embodiments will be described hereinafter with reference to the accompanying drawings.

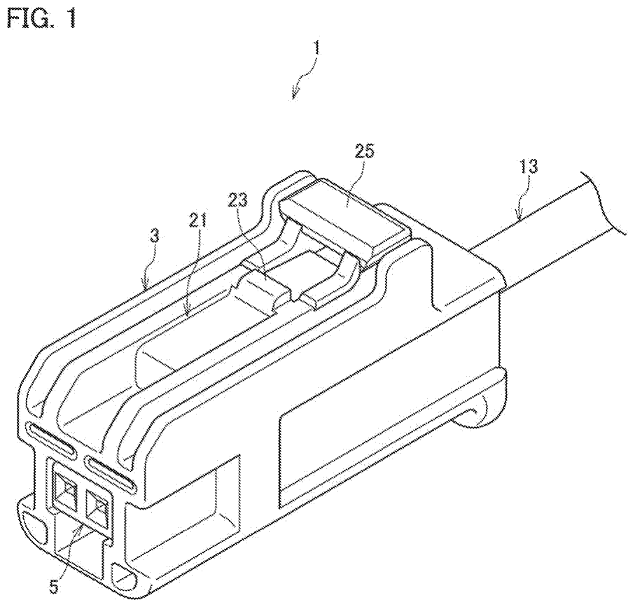

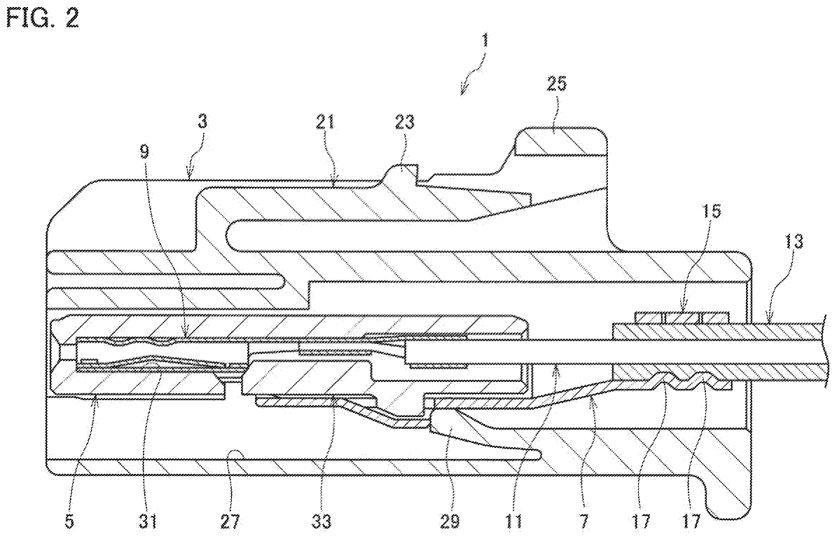

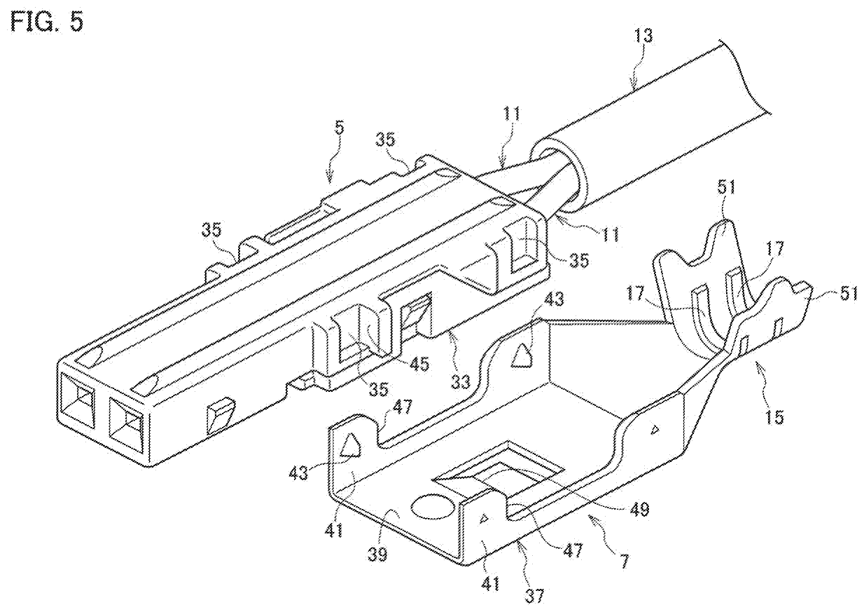

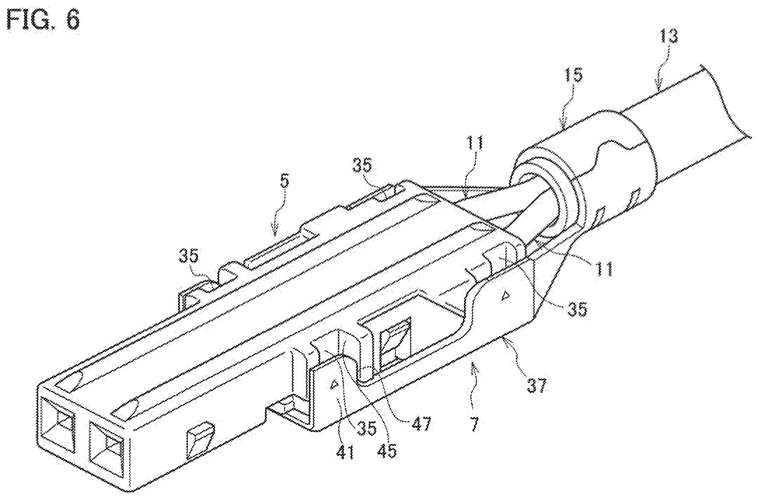

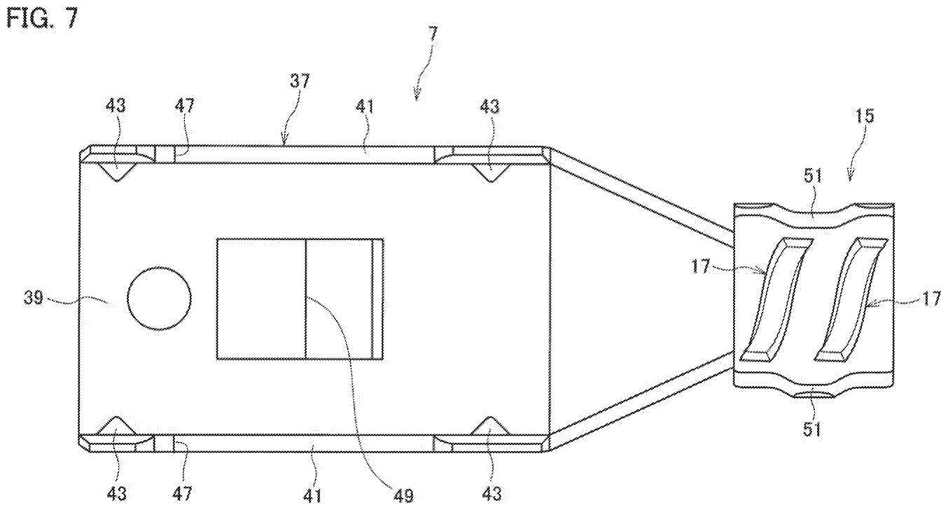

A connector according to an embodiment of the present invention will be described with reference to FIGS. 1 to 7.

A connector 1 according to the present embodiment includes an outer housing 3, an inner housing 5 housed and held in the outer housing 3, a jacket fixing member 7 attached to an outer periphery of the inner housing 5, a plurality of terminals 9 housed in the inner housing 5, a plurality of cables 11 with each end connected to each of the plurality of terminals 9 and drawn from the inner housing 5, a jacket 13 collectively covering an outer periphery of the plurality of cables 11 drawn from the inner housing 5, and a crimping section 15 provided on the jacket fixing member 7 and crimped to an outer periphery of the jacket 13.

The crimping section 15 is provided with a serration 17 protruding toward the jacket 13 and arranged inclined with respect to a longitudinal direction of the jacket 13.

In addition, a corner portion 19 of the serration 17 protruded toward the jacket is rounded.

Further, the serration 17 is provided in plural number.

As illustrated in FIGS. 1 to 7, the outer housing 3 is made of an insulating material such as synthetic resin, formed in a rectangular shape, and can be fit into a counterpart housing (not illustrated).

On an upper part of this outer housing 3, a lock arm 21, a member continuous with the outer housing 3 and oscillatable in a height direction, is provided.

The lock arm 21 is provided with a lock portion 23 that engages with a locked portion (not illustrated) provided in the counterpart housing while the outer housing 3 and the counterpart housing are fit into each other.

This lock arm 21 is bent downward, when the outer housing 3 and the counterpart housing are fit into each other, by sliding between the lock portion 23 and the locked portion. When the outer housing 3 and the counterpart housing are fit into each other, the lock arm 21 is restored upward, and the lock portion 23 engages with the locked portion.

Through this engagement between the lock portion 23 of the lock arm 21 and the locked portion of the counterpart housing, the fit between the outer housing 3 and the counterpart housing is maintained.

The lock arm 21 is provided with an operation section 25 that bends the lock arm 21 downward by pressing. By pressing the operation section 25, the engagement between the lock portion 23 and the locked portion is released, and the fit between the outer housing 3 and the counterpart housing can be released.

Inside the foregoing outer housing 3, a housing section 27 that can house the inner housing 5 is provided.

Inside the housing section 27, a locking lance 29 bendable in a height direction of the outer housing 3 is provided.

The locking lance 29 slides, by housing the inner housing 5 in the housing section 27 from an opening on one end side of the housing section 27 in a longitudinal direction, on the inner housing 5 and the jacket fixing member 7 attached to the inner housing 5 and is bent downward. When the inner housing 5 is positioned at a regular housed position in the housing section 27, the locking lance 29 is restored upward and locked to the jacket fixing member 7.

This locking of the locking lance 29 to the jacket fixing member 7 attached to the inner housing 5 prevents the inner housing 5 from coming out of the opening on one end side of the housing section 27 in the longitudinal direction, and the inner housing 5 is held in the housing section 27 of the outer housing 3.

The inner housing 5 is made of an insulating material such as synthetic resin and formed in a rectangular shape housable in the housing section 27.

Inside this inner housing 5 are provided a plurality (here, two) of terminal housing chambers 31 that can house a plurality (here, two) of terminals 9.

In the plurality of terminal housing chambers 31, the terminals 9 are each housed from an opening on one end side in a longitudinal direction and prevented, by locking members 33 attached from the outer periphery of the inner housing 5 toward the plurality of terminal housing chambers 31, from slipping from the terminal housing chambers 31.

The inner housing 5 with the terminals 9 each housed in this plurality of terminal housing chambers 31 is arranged, while being housed in the housing section 27 of the outer housing 3, such that a part on an opening side on the other end side of the terminal housing chambers 31 in the longitudinal direction corresponds with an opening on the other end side of the housing section 27 in the longitudinal direction.

On the outer periphery of the foregoing inner housing 5, a plurality (here, four) of engaging recesses 35 for attaching the jacket fixing member 7 is provided.

The jacket fixing member 7 is provided with a mounting section 37 and the crimping section 15 by subjecting a metal plate material to stamping, for example.

The mounting section 37 includes a bottom wall 39 arranged facing a bottom surface of the inner housing 5 and side walls 41 bent upward from both sides of the bottom wall 39 and arranged facing both side surfaces of the inner housing 5.

On inner surfaces of the side walls 41 of the mounting section 37, a plurality (here, four) of engaging projections 43 engaged with the plurality of engaging recesses 35 of the inner housing 5 is provided.

Through this engagement between the plurality of engaging recesses 35 and the plurality of engaging projections 43, the jacket fixing member 7 is attached to the outer periphery of the inner housing 5 by the mounting section 37.

Of these side walls 41 provided with the plurality of engaging projections 43, the side walls 41 positioned on a front side in an insertion direction into the outer housing 3 are provided, in a part opposite to abutted portions 45 provided in the inner housing 5 in a direction away from the outer housing 3, with abutting portions 47 abuttable to the abutted portions 45.

These abutting portions 47 can maintain, by abutting the abutted portions 45 of the inner housing 5, an arrangement position of the jacket fixing member 7 with respect to the inner housing 5 even when a tensile force is applied to the plurality of cables 11 drawn from the inner housing 5 and the jacket 13 in a direction away from the inner housing 5.

In addition, the bottom wall 39 of the mounting section 37 is provided with a locking portion 49 formed by cutting and raising and locked to the locking lance 29 of the outer housing 3 to prevent the jacket fixing member 7 from slipping from the outer housing 3.

The foregoing mounting section 37 is provided with a crimping section 15, a member continuous with the bottom wall 39 and the side walls 41.

The crimping section 15 includes a pair of crimping pieces 51 extending upward from the both sides of the bottom wall 39.

In this crimping section 15, the pair of the crimping pieces 51 is crimped by, for example, a jig to the outer periphery of the jacket 13 collectively covering the outer periphery of the plurality of cables 11 drawn from the inner housing 5.

The plurality of terminals 9 is each connected to the ends of the plurality of cables 11 arranged inside the jacket 13 crimped by the foregoing crimping section 15.

The plurality of terminals 9 (here, two) is female terminals having box-shaped connecting portions, each inserted into the plurality of terminal housing chambers 31 of the inner housing 5 from the openings on one end side in the longitudinal direction, and housed in a regular position in the terminal housing chambers 31.

Through fitting of the outer housing 3 into the counterpart housing, tab-like connecting portions of a plurality (here, two) of counterpart terminals (not illustrated) housed in the counterpart housing are each inserted from the opening on the other end side of the inner housing 5 in a longitudinal direction so that the plurality of terminals 9 is electrically connected to the plurality of counterpart terminals.

The foregoing plurality of terminals 9 is each electrically connected to the ends of the plurality of cables 11.

The plurality of cables 11 (here, two) is made of sheathed cables subjected to insulating sheath on an outer periphery of a core wire, with one end side in the longitudinal direction electrically connected to, for example, a power source or equipment and the other end side in the longitudinal direction electrically connected to the terminals 9 through crimping.

This plurality of cables 11, with the outer periphery thereof collectively covered with the jacket 13 and the terminals 9 housed in the inner housing 5, is drawn from the opening on one end side of the terminal housing chambers 31 in the longitudinal direction.

The jacket 13 is made of an insulating material, formed in a cylindrical shape, and collectively covers the outer periphery of the plurality of cables 11 drawn to outside the inner housing 5.

Inside the jacket 13, the two cables 11 are inserted but may be arranged twisted. The cables 11 arranged twisted inside the jacket 13 are called twisted pair cables.

To the outer periphery of an end of this jacket 13 on a side where the plurality of cables 11 is exposed, the crimping section 15 of the jacket fixing member 7 is crimped, and the jacket 13 is fixed to the jacket fixing member 7.

Incidentally, a space (gap) is formed between the plurality of cables 11 and the jacket 13.

When a space is formed between the plurality of cables 11 and the jacket 13, even if the crimping section 15 is crimped to the outer periphery of the jacket 13, a space may remain between the plurality of cables 11 and the jacket 13.

When a space remains between the plurality of cables 11 and the jacket 13, the jacket 13 escapes toward the plurality of cables 11 at the crimping section 15, and the holding force of the crimping section 15 with respect to the jacket 13 is reduced.

As a result, when a tensile force is applied to the plurality of cables 11 and the jacket 13 in the direction away from the inner housing 5, a crimping position, in the crimping section 15, with respect to the jacket 13 may be shifted, or the jacket 13 may be detached from the crimping section 15.

Thus, the crimping section 15 is provided with the serrations 17.

The serrations 17 are formed astride the pair of the crimping pieces 51 on a surface of the crimping section 15 on a side of the jacket 13 and provided in plural number (here, two) in the longitudinal direction of the jacket 13.

This plurality of serrations 17 is each protruded toward the jacket 13 by stamping the crimping section 15 on a side opposite to the jacket 13 and arranged inclined with respect to the longitudinal direction of the jacket 13.

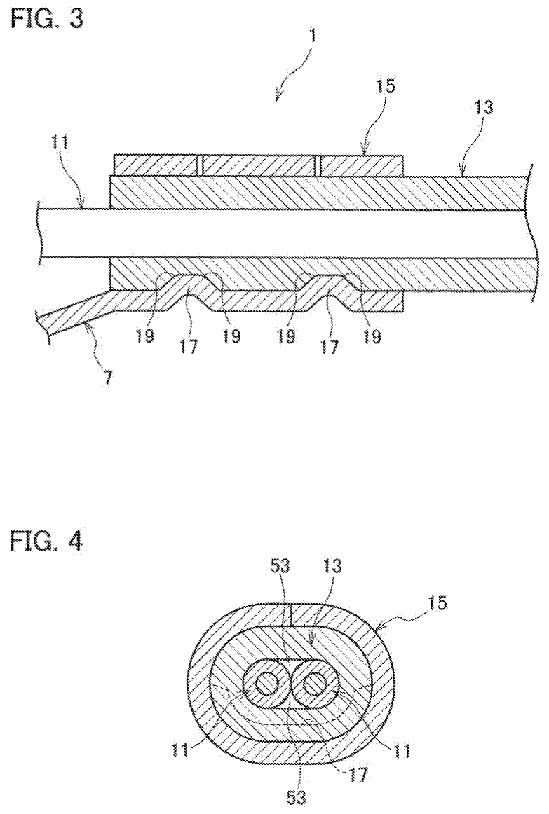

By providing the foregoing serrations 17 in the crimping section 15, for example, as illustrated in FIGS. 3 and 4, even if a space 53 remains between the jacket 13 and the cables 11 in the crimping section 15, the serrations 17 can be made bite into the outer peripheral surface of the jacket 13 when the crimping section 15 is crimped to the jacket 13.

Therefore, even if a tensile force is applied to the plurality of cables 11 and the jacket 13 in the direction away from the inner housing 5, the jacket 13 can be stably held in the crimping section 15.

In addition, since the serrations 17 are arranged inclined with respect to the longitudinal direction of the jacket 13, compared with a case where the serrations 17 are arranged orthogonal to the longitudinal direction of the jacket 13, a length of each serration 17 in the crimping section 15 can be increased, and a biting amount of the serration 17 with respect to the jacket 13 can be increased.

Accordingly, providing the foregoing serrations 17 in the crimping section 15 makes it possible to increase the holding force of the crimping section 15 with respect to the jacket 13 and prevent shifting of the crimping position, in the crimping section 15, with respect to the jacket 13 or detachment of the jacket 13 from the crimping section 15.

Here, the corner portions 19 of the serrations 17 protruded toward the jacket is rounded.

By forming the corner portions 19 to be rounded, even if a tensile force is applied to the plurality of cables 11 and the jacket 13 in the direction away from the inner housing 5, the corner portions 19 of the serrations 17 that have bitten into the outer peripheral surface of the jacket 13 can prevent damages to the jacket 13 such as the jacket 13 being torn.

Attachment of the foregoing connector 1 is performed by first connecting the plurality of terminals 9 to the respective ends of the plurality of cables 11 exposed from the jacket 13 and housing the respective plurality of terminals 9 in the plurality of terminal housing chambers 31 of the inner housing 5.

Next, the plurality of engaging projections 43 provided on the mounting section 37 of the jacket fixing member 7 is engaged with the plurality of engaging recesses 35 of the inner housing 5, and the jacket fixing member 7 is attached to the outer periphery of the inner housing 5.

Next, the crimping section 15 of the jacket fixing member 7 is crimped by, for example, a jig to the outer periphery of the jacket 13, and the jacket 13 is fixed to the jacket fixing member 7.

Then, the inner housing 5 is inserted into the housing section 27 of the outer housing 3, and the locking lance 29 is locked to the jacket fixing member 7 attached to the inner housing 5 to complete the attachment of the connector 1.

In the foregoing connector 1, the crimping section 15 is provided with the serrations 17 protruding toward the jacket 13 and arranged inclined with respect to the longitudinal direction of the jacket 13. Thus, when the crimping section 15 is crimped to the outer periphery of the jacket 13, the serrations 17 can be arranged to bite into the outer periphery of the jacket 13.

Further, since the serrations 17 are arranged inclined with respect to the longitudinal direction of the jacket 13, compared with the case where the serrations 17 are arranged orthogonal to the longitudinal direction of the jacket 13, the length of each serration 17 in the crimping section 15 can be increased, and the biting amount of the serration 17 with respect to the jacket 13 can be increased.

Therefore, in the foregoing connector 1, even if a space remains between the plurality of cables 11 and the jacket 13, the serrations 17 can be made stably bite into the outer periphery of the jacket 13, and the holding force of the crimping section 15 with respect to the jacket 13 can be improved.

Further, since the corner portions 19 of the serrations 17 protruded toward the jacket is rounded, when a tensile force is applied to the plurality of cables 11 and the jacket 13, the corner portions 19 of the serrations 17 can prevent damages to the jacket 13.

Furthermore, since the plurality of serration 17 is formed on the crimping section, the holding force of the crimping section 15 with respect to the jacket 13 can be further improved.

In the connector according to the embodiment of the present invention, the number of the serrations is, but not limited to, two and may be one or three or more.

In addition, the numbers of the terminals and the cables are, but not limited to, two, respectively and may be three or more, respectively.

Furthermore, the terminals are, but not limited to, female terminals and may be male terminals having tab-like connecting portions.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A connector comprising:
an outer housing;
an inner housing housed and held in the outer housing;
a jacket fixing member attached to an outer periphery of the inner housing;
a plurality of terminals housed in the inner housing;
a plurality of cables with each end connected to each of the plurality of terminals and drawn from the inner housing;
a jacket collectively covering an outer periphery of the plurality of cables drawn from the inner housing;
a crimping section formed on the jacket fixing member and crimped to an outer periphery of the jacket; and
at least one serration formed on the crimping section, protruding toward the jacket, and arranged inclined with respect to a longitudinal direction of the jacket.

2. The connector according to claim 1, wherein a corner portion of the at least one serration protruded toward the jacket is rounded.

3. The connector according to claim 1, wherein the at least one serration comprises a plurality of serrations.
